(19) United States
(12) Patent Application Publication
(10) Pub. No.: US 2025/0304282 A1
(43) Pub. Date: Oct. 2, 2025

(54) GRAPHENE-INFUSED WOODEN STRUCTURES FOR SATELLITE APPLICATIONS

(71) Applicant: Khalifa University of Science and Technology, Abu Dhabi (AE)

(72) Inventors: Basel Altawil, Abu Dhabi (AE); Afnan Malik, Abu Dhabi (AE); Rami Elkaffas, Abu Dhabi (AE); Yarjan Abdul Samad, Abu Dhabi (AE); Sean Swei, Abu Dhabi (AE); Fahad Rashed Al Absi, Abu Dhabi (AE)

(21) Appl. No.: 19/093,756

(22) Filed: Mar. 28, 2025

Related U.S. Application Data
(60) Provisional application No. 63/571,705, filed on Mar. 29, 2024.

(51) Int. Cl. B64G 1/10; B27K 3/16

(52) U.S. Cl. CPC B64G 1/10; B27K 3/16

(57) ABSTRACT

The present disclosure is directed to a space satellite structure comprising: a bottom base comprising a first graphene-infused wood bracket; a top base comprising a second graphene-infused wood bracket; a set of graphene-infused wood ribs coupled to and extending between the bottom base and the top base; a set of stainless steel threaded bars coupled to and extending between the bottom base and the top base, each stainless steel threaded bar of the set of stainless steel threaded bars being adjacent to a graphene-infused wood rib of the set of graphene-infused wood ribs; a first set of graphene-infused wood blocks coupled to a bottom side of the bottom base; and a second set of graphene-infused wood blocks coupled to a top side of the top base.

### CROSS-REFERENCES TO RELATED APPLICATIONS

This application claims the benefit of U.S. Provisional Patent Application No. 63/571,705, filed Mar. 29, 2024, the entire contents of which are hereby incorporated by reference for all purposes in its entirety.

### BACKGROUND OF THE INVENTION

From the inception of space exploration, metallic materials have been a cornerstone in the construction of spacecraft structures, predominantly due to their advantageous mechanical and thermal properties. Metals such as aluminum have served as the foundation of satellite design, demonstrating resilience to the extreme thermal fluctuations encountered in space and the intense vibrational forces experienced during launch. Their inherent strength, durability, and established reliability have rendered them indispensable in an industry where the margin for error is minimal and the consequences of failure are substantial.

Nevertheless, as the scope of human activities in space has expanded, the complexity and scale of associated challenges have similarly grown. A pressing issue in contemporary space exploration is the escalating congestion within Low Earth Orbit (LEO). This region, densely populated with operational satellites and various spaceborne objects, is increasingly threatened by the proliferation of space debris. The accumulation of inactive satellites, expended rocket stages, and collision-generated fragments has emerged as a significant hazard to active spacecraft and prospective missions.

Addressing the deorbiting of these objects has become a critical priority. Conventional metallic spacecraft structures, upon deorbit, have the potential to generate hazardous debris. Specifically, components composed of aluminum are capable of surviving the intense thermal conditions of atmospheric re-entry, thereby posing risks of impacting the Earth's surface. This scenario not only endangers human life and property but also raises profound environmental concerns due to the toxic nature of such debris.

Thus, a need remains for a material that is able to operate at a level similar to known metallic spacecraft structures but that does not have the same deorbiting and environmental concerns of known metallic spacecraft structures.

### BRIEF SUMMARY OF THE INVENTION

Covered embodiments of the present disclosure are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings and each claim.

In some embodiments, the present disclosure is directed to a space satellite structure comprising: a bottom base comprising a first graphene-infused wood bracket; a top base comprising a second graphene-infused wood bracket; a set of graphene-infused wood ribs coupled to and extending between the bottom base and the top base; a set of stainless steel threaded bars coupled to and extending between the bottom base and the top base, each stainless steel threaded bar of the set of stainless steel threaded bars being adjacent to a graphene-infused wood rib of the set of graphene-infused wood ribs; a first set of graphene-infused wood blocks coupled to a bottom side of the bottom base; and a second set of graphene-infused wood blocks coupled to a top side of the top base. In some aspects, the first graphene-infused wood bracket comprises from 0.1 to 60% graphene, by weight. In some aspects, the second graphene-infused wood bracket comprises from 0.1 to 60% graphene, by weight. In some aspects, at least one of the wood ribs of the set of graphene-infused wood ribs comprises from 0.1 to 60% graphene, by weight. In some aspects, each of the wood ribs of the set of graphene-infused wood ribs comprises from 0.1 to 60% graphene, by weight. In some aspects, at least one of the graphene-infused blocks of the first set of graphene-infused blocks comprises from 0.1 to 60% graphene, by weight. In some aspects, each of the graphene-infused blocks of the first set of graphene-infused blocks comprises from 0.1 to 60% graphene, by weight. In some aspects, at least one of the graphene-infused blocks of the second set of graphene-infused blocks comprises from 0.1 to 60% graphene, by weight. In some aspects, each of the graphene-infused blocks of the second set of graphene-infused blocks comprises from 0.1 to 60% graphene, by weight. The space satellite may further comprise at least one solar panel. The space satellite structure may contain less than 20 individual parts. The space satellite structure may contain less than 10 screws. In some aspects, at least one side of the space satellite structure is more than 80% open space.

In some embodiments, the present disclosure is directed to a method of forming a graphene-infused wood for the space satellite structure. The space satellite structure may be that described in the above paragraph. The method may comprise: providing natural wood; delignifying the natural wood to form a shrunken natural wood comprising pores; and depositing graphene into the pores to form graphene-infused wood. In some aspects, the graphene is deposited on an inner surfaces of cell walls and fibers of the shrunken wood. The depositing step may comprise depositing from 1 to 50 g/L of a graphene dispersion into the pores of the shrunken natural wood. The graphene-infused wood may have an electrical conductivity of greater than 0 S/m. The graphene-infused wood may have an electrical conductivity from 0.1 to 100 S/m. The graphene-infused wood may have a density from 0.2 to 0.8 g/cm³. The graphene-infused wood may have a shielding efficiency of at least 10 dB.

Further aspects, objects, and advantages will become apparent upon consideration of the detailed description.

### BRIEF DESCRIPTION OF THE DRAWINGS

The foregoing aspects and others will be readily appreciated by the skilled artisan from the following description of illustrative embodiments when read in conjunction with the accompanying drawings.

FIGS. 1A-C show images of natural wood, delignified wood, and graphene-infused wood, respectively, in accordance with embodiments of the present disclosure.

FIGS. 1D-F show SEM images of natural wood, delignified wood, and graphene-infused wood, respectively, in accordance with embodiments of the present disclosure.

FIG. 1G shows an image of natural wood converted to delignified wood in accordance with embodiments of the present disclosure.

FIG. 1H shows an image of delignified wood converted to graphene-infused wood in accordance with embodiments of the present disclosure.

FIGS. 2A-D show the effect of the delignification process on graphene deposition in accordance with embodiments of the present disclosure.

FIG. 3 shows a chart comparing shielding efficiency in accordance with embodiments of the present disclosure.

FIG. 4 shows a chart comparing conductivity in accordance with embodiments of the present disclosure.

FIG. 5 shows a set-up for testing of performance temperature and disintegration performance in accordance with embodiments of the present disclosure.

FIG. 6 shows an image of a sample irradiated with a laser beam in accordance with embodiments of the present disclosure.

FIG. 7 shows an image of a satellite structure in accordance with embodiments of the present disclosure.

FIG. 8 shows an image of a satellite structure in accordance with embodiments of the present disclosure.

### DETAILED DESCRIPTION

Before the present disclosure is described in detail, it is to be understood that the terminology used herein is for purposes of describing particular examples and embodiments only, and is not intended to be limiting.

In this specification and in the claims that follow, reference will be made to a number of terms that shall be defined to have the following meanings:

### Definitions

As used herein, the terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

Unless defined otherwise, all technical and scientific terms used herein have the same meaning as commonly understood by one of ordinary skill in the art to which this invention belongs. Although, any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

### INTRODUCTION

The present disclosure is directed to space satellite structures comprising graphene-infused wood as well as method of making the same. In response to challenges with deorbiting and environmental concerns described above, there is a growing interest in exploring alternative materials for satellite construction. The concept of using wood-based materials, infused with graphene, represents a transformative shift in satellite design philosophy. Wood, a naturally occurring, renewable, and biodegradable material, offers an eco-friendly alternative to traditional metal alloys. When enhanced with graphene, known for its strength, electrical conductivity, and thermal properties, wood may meet the rigorous demands of space applications.

The infusion of graphene into wood-based structures may address several key issues. Firstly, it may significantly reduce the risk of harmful debris upon re-entry, as wooden structures are more likely to disintegrate harmlessly in the Earth's atmosphere. Secondly, the use of renewable materials aligns with the growing global emphasis on sustainability and reducing the environmental impact of human activities, including space exploration.

This shift in material science for space applications, from traditional metals to innovative graphene-infused wooden structures, represents not a technological advancement, but also a commitment to preserving the space environment and the planet.

The present disclosure describes a way to revolutionize satellite structure design by harnessing the intrinsic benefits of wood, while simultaneously enhancing its properties to meet the rigorous demands of space applications. By infusing wood with graphene, the composite material merges the best characteristics of both components.

A satellite structure with graphene-infused wooden components may provide enhanced mechanical strength. One of the primary challenges in using wood for space applications is its relative mechanical weakness when compared to traditional metals. Graphene, known for its incredible tensile strength, which is even stronger than steel, can be incorporated into the wooden structure at a molecular level. This integration of graphene can impart exceptional rigidity and durability to the wood, making it suitable for withstanding the intense vibrations during satellite launches and the harsh conditions of space.

Graphene-infused wooden satellite structures may also provide improved thermal and radiation resistance. Space is an environment characterized by extreme temperatures and high radiation levels. While wood inherently offers some degree of thermal insulation, its resilience to prolonged exposure to these conditions is limited. By infusing the wood with graphene, the thermal resistance can be significantly elevated. Graphene's unique atomic structure also acts as a shield, reducing the penetration of harmful space radiation, thus ensuring the longevity of the satellite's components and systems.

Graphene-infused wooden satellite structures can also involve lightweight construction. One of the paramount considerations in satellite design is weight. Heavier satellites are more costly to launch and pose challenges in terms of propulsion and maneuverability. Wood, by its nature, is lightweight. When combined with graphene, the resulting composite retains its low weight, ensuring that satellites can be launched more cost-effectively and efficiently.

Graphene-infused wooden satellite structures can also provide improved sustainability and eco-friendliness. As emphasized earlier, the move towards wood-based satellite structures is not just about performance, but also about sustainability. Wood is renewable and biodegradable. In the unfortunate event of satellite debris re-entering the Earth's atmosphere, a graphene-infused wooden structure poses less environmental risk than its metal counterparts. The graphene-infused wooden structure is more likely to disintegrate completely, leaving minimal to no harmful residues.

Graphene-infused wooden satellite structures may also provide manufacturing and scalability benefits. The process of infusing wood with graphene is designed to be scalable, allowing for mass production of these structures. By leveraging advanced nanotechnology techniques, the dispersion of graphene can be uniform throughout the wooden matrix, achieving consistency in performance across multiple batches.

In summary, the present disclosure represents a bold step forward in satellite construction, offering a blend of performance, sustainability, and economic feasibility. By melding the natural advantages of wood with the cutting-edge properties of graphene, we envision a new era of space exploration, marked by responsible and innovative engineering solutions.

### Space Satellite Structure

As described herein, the space satellite structure may have a bottom base, a top base, a set of ribs coupled to and extending between the top base and bottom base. The structure may also have a set of threaded bars coupled to and extending between the bottom base and the top base. The structure may also have sets of blocks coupled to the bottom base or top base. In some aspects, a first set of graphene-infused wood blocks is coupled to a bottom side of the bottom base; and a second set of graphene-infused wood blocks is coupled to a top side of the top base.

Graphene-infused wood may be used in many of the structural pieces of the space satellite structure. The bottom base may comprise a first graphene-infused wood bracket. The top base may also comprise a second graphene-infused wood bracket. The wood ribs may also be graphene-infused wood ribs. The wood blocks may be graphene-infused wood blocks. The threaded bars may be formed from stainless steel and may be adjacent to the graphene-infused wood ribs.

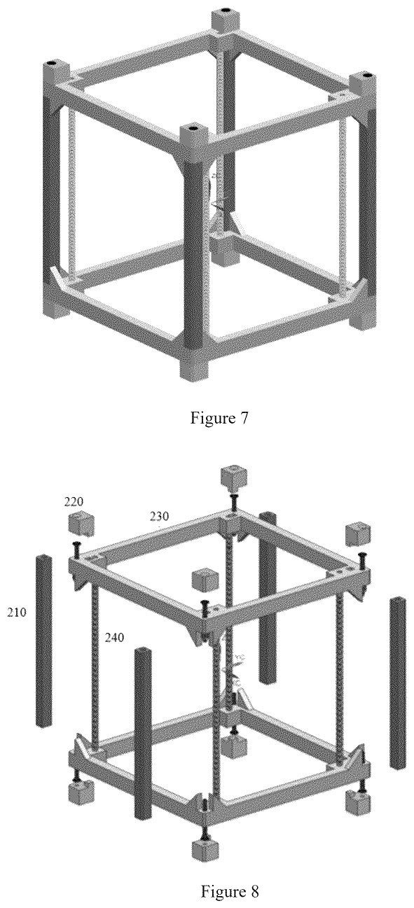

FIG. 7 provides an overall view of a space satellite structure described herein. FIG. 8 shows an exploded view of a space satellite structure described herein. Element 210 shows a graphene-infused wood rib. Such graphene-infused wood ribs may be found connecting each corner of the bottom base to the top base of the structure. Element 220 shows a graphene-infused wood block. Such graphene-infused wood blocks may be found, as shown, at each corner of the top base and at each corner of the bottom base. Element 230 shows a graphene-infused wood bracket that can be included on each of the top and bottom base. And element 240 shows a stainless steel threaded bar that may also be included at each corner, connecting the top and bottom bases. Screws may be included to attach the graphene-infused wood block to the top and bottom bases.

As shown in FIGS. 7 and 8, the design of the graphene-infused wooden satellite structure can include symmetrical top and bottom bases. The foundation of the satellite's structure relies on two symmetrical bases positioned at the top and bottom. This design ensures stability, balance, and uniform distribution of weight, essential for the satellite's optimal functioning in space.

The design of the space satellite structure may also include stainless steel bars for component mounting. In some aspects, four stainless steel bars can be strategically placed within the structure. They are designed to hold the satellite's components securely in a fixed position, utilizing standard vertical alignments. This arrangement ensures that the components remain stationary, even in the dynamic environment of space.

In an example, a space satellite structure can include a bottom base including a first graphene-infused wood bracket and a top base including a second graphene-infused wood bracket. Each of the top base and the bottom base may be a square shape, a rectangular shape, or any other suitable shape. The space satellite structure can also include a set of graphene-infused wood ribs and a set of stainless steel threaded bars. Each of the graphene-infused wood ribs and the stainless steel threaded bars can be coupled to and extend between the bottom base and the top base. For instance, if the bottom base and the top base are squares, the graphene-infused wood ribs and the stainless steel threaded bars can be coupled to each corner of the bottom base and the top base, with the stainless steel threaded bars being adjacent to (e.g., behind) the graphene-infused wood ribs. In addition, the space satellite structure can include a first set of graphene-infused wood blocks coupled to a bottom side of the bottom base and a second set of graphene-infused wood blocks coupled to a top side of the top base. The sets of graphene-infused wood blocks may be coupled to the corners of the top base and the bottom base.

In some aspects, the first graphene-infused wood bracket may comprise from 0.1 to 60% graphene, by weight. For example, the first graphene-infused wood bracket may comprise from 0.1 to 55%, from 0.1 to 50%, from 0.1 to 45%, from 0.1 to 40%, from 0.1 to 35%, from 0.1 to 30%, from 0.1 to 25%, from 0.1 to 20%, from 0.1 to 15%, from 0.1 to 10%, from 0.1 to 5%, from 0.1 to 1%, from 0.5 to 60%, from 0.5 to 55%, from 0.5 to 50%, from 0.5 to 45%, from 0.5 to 40%, from 0.5 to 35%, from 0.5 to 30%, from 0.5 to 25%, from 0.5 to 20%, from 0.5 to 15%, from 0.5 to 10%, from 0.5 to 5%, from 0.5 to 1%, from 1 to 60%, from 1 to 55%, from 1 to 50%, from 1 to 45%, from 1 to 40%, from 1 to 35%, from 1 to 30%, from 1 to 25%, from 1 to 20%, from 1 to 15%, from 1 to 10%, from 1 to 5%, from 3 to 60%, from 3 to 55%, from 3 to 50%, from 3 to 45%, from 3 to 40%, from 3 to 35%, from 3 to 30%, from 3 to 25%, from 3 to 20%, from 3 to 15%, from 3 to 10%, from 3 to 5%, from 5 to 60%, from 5 to 55%, from 5 to 50%, from 5 to 45%, from 5 to 40%, from 5 to 35%, from 5 to 30%, from 5 to 25%, from 5 to 20%, from 5 to 15%, from 5 to 10%, from 10 to 60%, from 10 to 55%, from 10 to 50%, from 10 to 45%, from 10 to 40%, from 10 to 35%, from 10 to 30%, from 10 to 25%, from 10 to 20%, from 10 to 15%, from 15 to 60%, from 15 to 55%, from 15 to 50%, from 15 to 45%, from 15 to 40%, from 15 to 35%, from 15 to 30%, from 15 to 25%, from 15 to 20%, from 20 to 60%, from 20 to 55%, from 20 to 50%, from 20 to 45%, from 20 to 40%, from 20 to 35%, from 20 to 30%, from 20 to 25%, from 25 to 60%, from 25 to 55%, from 25 to 50%, from 25 to 45%, from 25 to 40%, from 25 to 35%, from 25 to 30%, from 30 to 60%, from 30 to 55%, from 30 to 50%, from 30 to 45%, from 30 to 40%, from 30 to 35%, from 35 to 60%, from 35 to 55%, from 35 to 50%, from 35 to 45%, from 35 to 40%, from 40 to 60%, from 40 to 55%, from 40 to 50%, from 40 to 55%, from 45 to 60%, from 45 to 55%, from 45 to 50%, from 50 to 60%, from 50 to 55%, or from 55 to 60% graphene by weight.

In some aspects, the second graphene-infused wood bracket may comprise from 0.1 to 60% graphene, by weight. For example, the second graphene-infused wood bracket may comprise from 0.1 to 55%, from 0.1 to 50%, from 0.1 to 45%, from 0.1 to 40%, from 0.1 to 35%, from 0.1 to 30%, from 0.1 to 25%, from 0.1 to 20%, from 0.1 to 15%, from 0.1 to 10%, from 0.1 to 5%, from 0.1 to 1%, from 0.5 to 60%, from 0.5 to 55%, from 0.5 to 50%, from 0.5 to 45%, from 0.5 to 40%, from 0.5 to 35%, from 0.5 to 30%, from 0.5 to 25%, from 0.5 to 20%, from 0.5 to 15%, from 0.5 to 10%, from 0.5 to 5%, from 0.5 to 1%, from 1 to 60%, from 1 to 55%, from 1 to 50%, from 1 to 45%, from 1 to 40%, from 1 to 35%, from 1 to 30%, from 1 to 25%, from 1 to 20%, from 1 to 15%, from 1 to 10%, from 1 to 5%, from 3 to 60%, from 3 to 55%, from 3 to 50%, from 3 to 45%, from 3 to 40%, from 3 to 35%, from 3 to 30%, from 3 to 25%, from 3 to 20%, from 3 to 15%, from 3 to 10%, from 3 to 5%, from 5 to 60%, from 5 to 55%, from 5 to 50%, from 5 to 45%, from 5 to 40%, from 5 to 35%, from 5 to 30%, from 5 to 25%, from 5 to 20%, from 5 to 15%, from 5 to 10%, from 10 to 60%, from 10 to 55%, from 10 to 50%, from 10 to 45%, from 10 to 40%, from 10 to 35%, from 10 to 30%, from 10 to 25%, from 10 to 20%, from 10 to 15%, from 15 to 60%, from 15 to 55%, from 15 to 50%, from 15 to 45%, from 15 to 40%, from 15 to 35%, from 15 to 30%, from 15 to 25%, from 15 to 20%, from 20 to 60%, from 20 to 55%, from 20 to 50%, from 20 to 45%, from 20 to 40%, from 20 to 35%, from 20 to 30%, from 20 to 25%, from 25 to 60%, from 25 to 55%, from 25 to 50%, from 25 to 45%, from 25 to 40%, from 25 to 35%, from 25 to 30%, from 30 to 60%, from 30 to 55%, from 30 to 50%, from 30 to 45%, from 30 to 40%, from 30 to 35%, from 35 to 60%, from 35 to 55%, from 35 to 50%, from 35 to 45%, from 35 to 40%, from 40 to 60%, from 40 to 55%, from 40 to 50%, from 40 to 55%, from 45 to 60%, from 45 to 55%, from 45 to 50%, from 50 to 60%, from 50 to 55%, or from 55 to 60% graphene by weight.

In some aspects, at least one of the wood ribs of the set of graphene-infused wood ribs may comprise from 0.1 to 60% graphene, by weight. For example, at least one of the wood ribs of the set of graphene-infused wood ribs may comprise from 0.1 to 55%, from 0.1 to 50%, from 0.1 to 45%, from 0.1 to 40%, from 0.1 to 35%, from 0.1 to 30%, from 0.1 to 25%, from 0.1 to 20%, from 0.1 to 15%, from 0.1 to 10%, from 0.1 to 5%, from 0.1 to 1%, from 0.5 to 60%, from 0.5 to 55%, from 0.5 to 50%, from 0.5 to 45%, from 0.5 to 40%, from 0.5 to 35%, from 0.5 to 30%, from 0.5 to 25%, from 0.5 to 20%, from 0.5 to 15%, from 0.5 to 10%, from 0.5 to 5%, from 0.5 to 1%, from 1 to 60%, from 1 to 55%, from 1 to 50%, from 1 to 45%, from 1 to 40%, from 1 to 35%, from 1 to 30%, from 1 to 25%, from 1 to 20%, from 1 to 15%, from 1 to 10%, from 1 to 5%, from 3 to 60%, from 3 to 55%, from 3 to 50%, from 3 to 45%, from 3 to 40%, from 3 to 35%, from 3 to 30%, from 3 to 25%, from 3 to 20%, from 3 to 15%, from 3 to 10%, from 3 to 5%, from 5 to 60%, from 5 to 55%, from 5 to 50%, from 5 to 45%, from 5 to 40%, from 5 to 35%, from 5 to 30%, from 5 to 25%, from 5 to 20%, from 5 to 15%, from 5 to 10%, from 10 to 60%, from 10 to 55%, from 10 to 50%, from 10 to 45%, from 10 to 40%, from 10 to 35%, from 10 to 30%, from 10 to 25%, from 10 to 20%, from 10 to 15%, from 15 to 60%, from 15 to 55%, from 15 to 50%, from 15 to 45%, from 15 to 40%, from 15 to 35%, from 15 to 30%, from 15 to 25%, from 15 to 20%, from 20 to 60%, from 20 to 55%, from 20 to 50%, from 20 to 45%, from 20 to 40%, from 20 to 35%, from 20 to 30%, from 20 to 25%, from 25 to 60%, from 25 to 55%, from 25 to 50%, from 25 to 45%, from 25 to 40%, from 25 to 35%, from 25 to 30%, from 30 to 60%, from 30 to 55%, from 30 to 50%, from 30 to 45%, from 30 to 40%, from 30 to 35%, from 35 to 60%, from 35 to 55%, from 35 to 50%, from 35 to 45%, from 35 to 40%, from 40 to 60%, from 40 to 55%, from 40 to 50%, from 40 to 55%, from 45 to 60%, from 45 to 55%, from 45 to 50%, from 50 to 60%, from 50 to 55%, or from 55 to 60% graphene by weight. In some aspects, more than one of the graphene-infused wood ribs, e.g., two of the graphene-infused wood ribs, graphene-infused three of the wood ribs, graphene-infused four of the wood ribs, or all of the graphene-infused wood ribs, regardless of the number, may contain graphene in the amounts described above.

In some aspects, at least one of the graphene-infused wood block from the first and/or second set of graphene-infused wood blocks may comprise from 0.1 to 60% graphene, by weight. For example, at least one of the graphene-infused wood blocks may comprise from 0.1 to 55%, from 0.1 to 50%, from 0.1 to 45%, from 0.1 to 40%, from 0.1 to 35%, from 0.1 to 30%, from 0.1 to 25%, from 0.1 to 20%, from 0.1 to 15%, from 0.1 to 10%, from 0.1 to 5%, from 0.1 to 1%, from 0.5 to 60%, from 0.5 to 55%, from 0.5 to 50%, from 0.5 to 45%, from 0.5 to 40%, from 0.5 to 35%, from 0.5 to 30%, from 0.5 to 25%, from 0.5 to 20%, from 0.5 to 15%, from 0.5 to 10%, from 0.5 to 5%, from 0.5 to 1%, from 1 to 60%, from 1 to 55%, from 1 to 50%, from 1 to 45%, from 1 to 40%, from 1 to 35%, from 1 to 30%, from 1 to 25%, from 1 to 20%, from 1 to 15%, from 1 to 10%, from 1 to 5%, from 3 to 60%, from 3 to 55%, from 3 to 50%, from 3 to 45%, from 3 to 40%, from 3 to 35%, from 3 to 30%, from 3 to 25%, from 3 to 20%, from 3 to 15%, from 3 to 10%, from 3 to 5%, from 5 to 60%, from 5 to 55%, from 5 to 50%, from 5 to 45%, from 5 to 40%, from 5 to 35%, from 5 to 30%, from 5 to 25%, from 5 to 20%, from 5 to 15%, from 5 to 10%, from 10 to 60%, from 10 to 55%, from 10 to 50%, from 10 to 45%, from 10 to 40%, from 10 to 35%, from 10 to 30%, from 10 to 25%, from 10 to 20%, from 10 to 15%, from 15 to 60%, from 15 to 55%, from 15 to 50%, from 15 to 45%, from 15 to 40%, from 15 to 35%, from 15 to 30%, from 15 to 25%, from 15 to 20%, from 20 to 60%, from 20 to 55%, from 20 to 50%, from 20 to 45%, from 20 to 40%, from 20 to 35%, from 20 to 30%, from 20 to 25%, from 25 to 60%, from 25 to 55%, from 25 to 50%, from 25 to 45%, from 25 to 40%, from 25 to 35%, from 25 to 30%, from 30 to 60%, from 30 to 55%, from 30 to 50%, from 30 to 45%, from 30 to 40%, from 30 to 35%, from 35 to 60%, from 35 to 55%, from 35 to 50%, from 35 to 45%, from 35 to 40%, from 40 to 60%, from 40 to 55%, from 40 to 50%, from 40 to 55%, from 45 to 60%, from 45 to 55%, from 45 to 50%, from 50 to 60%, from 50 to 55%, or from 55 to 60% graphene by weight. In some aspects, more than one of the graphene-infused wood blocks, e.g., two of the graphene-infused wood blocks, three of the graphene-infused wood blocks, four of the graphene-infused wood blocks, five of the graphene-infused wood blocks, six of the graphene-infused wood blocks, seven of the graphene-infused wood blocks, eight of the graphene-infused wood blocks, or all of the graphene-infused wood blocks, regardless of the number, may contain graphene in the amounts described above.

In some aspects, the space satellite structure may further comprise a solar panel. For example, the structure may include 1 to 10 solar panels, 1 to 8 solar panels, 1 to 6 solar panels, 2 to 10 solar panels, 4 to 10 solar panels, 6 to 10 solar panels, 4 to 8 solar panels, or 6 solar panels. of these panels can house two cells, providing ample energy for the satellite's operations. The integration of solar panels is important for maintaining power levels, ensuring that the satellite remains operational for extended durations.

In some aspects, the space satellite structure contains less than 20 individual parts, e.g., from 10 to 20 parts, from 10 to 18 parts, from 10 to 16 parts, from 12 to 16 parts, or 15 parts. In some aspects, the space satellite structure contains less than 10 screws (counted separately from the “parts”), e.g., 8 screws. This streamlined design approach not only reduces manufacturing complexity but also minimizes potential points of failure. The fewer the components, the lower the risk of malfunctions. The design of the space satellite structure can also include minimalistic assembly. One of the features of this design is the case of assembly. In an example, as described herein, only eight screws may be used to hold the entire structure together, reducing the chances of mechanical failures and simplifying maintenance procedures.

In some aspects, the design of the space satellite structure is such that at least one side of the structure, such as that shown in FIGS. 7 and 9, is at least 80% open, e.g., at least 85% open or at least 90% open. The thickness and length of each structural part may be selected to achieve this sizing. The satellite's sides are designed to be more than 80% open, providing flexibility for camera mounting. Engineers have the liberty to position a camera anywhere on the structure, depending on mission requirements. This feature is particularly advantageous for observational or imaging satellites, ensuring that the field of view is minimally or never compromised.

The present disclosure is also directed to methods of forming the space satellite structures described herein. The structure shown in FIGS. 7 and 9 is non-limiting but provides a view of the overall design. For each part of the space satellite device that contains graphene-infused wood, the graphene-infused wood can be prepared as described below.

In a first step, natural wood may be provided as a starting material. Natural wood refers to wood that has not been purposefully delignified to form pores and to have a reduced density relative to the natural state of the wood. Wood sources included hardwood and softwood. Softwood is a generic term typically used in reference to wood from conifers (i.e., needle-bearing trees from the order Pinales). Softwood-producing trees include pine, spruce, cedar, fir, larch, douglas-fir, hemlock, cypress, redwood and yew. Conversely, the term hardwood is typically used in reference to wood from broad-leaved or angiosperm trees. The terms “softwood” and “hardwood” do not necessarily describe the actual hardness of the wood. While, on average, hardwood is of higher density and hardness than softwood, there is considerable variation in actual wood hardness in both groups, and some softwood trees can actually produce wood that is harder than wood from hardwood trees. One feature separating hardwoods from softwoods is the presence of pores, or vessels, in hardwood trees, which are absent in softwood trees. On a microscopic level, softwood contains two types of cells, longitudinal wood fibers (or tracheids) and transverse ray cells. In softwood, water transport within the tree is via the tracheids rather than the pores of hardwoods.

The natural wood may be delignified according to known methods, including by using alkaline treatment, such as sodium hydroxide, followed by bleaching with hydrogen peroxide. Other methods include steam explosion and solvent extraction. Known alkaline treatment methods include the Kraft process. Additional options include using eutectic solvents, ionic liquids, or solution steaming. After removal of lignin, the wood may be referred to as shrunken wood. The pore size formed in the shrunken wood may depend on the method used to remove lignin, as well as the wood source. In some aspects, the pore size may range from 1 nm to 1000 microns, e.g., from 10 nm to 1000 microns, from 100 nm to 1000 microns, from 500 nm to 1000 microns, from 1 micron to 1000 microns, from 10 microns to 1000 microns, from 100 microns to 1000 microns, from 500 microns to 1000 microns, from 1 nm to 750 microns, from 10 nm to 750 microns, from 100 nm to 750 microns, from 500 nm to 750 microns, from 1 micron to 750 microns, from 10 microns to 750 microns, from 100 microns to 750 microns, from 500 microns to 750 microns, from 1 nm to 500 microns, from 10 nm to 500 microns, from 100 nm to 500 microns, from 500 nm to 500 microns, from 1 micron to 500 microns, from 10 microns to 500 microns, from 100 microns to 500 microns, from 1 nm to 250 microns, from 10 nm to 250 microns, from 100 nm to 250 microns, from 500 nm to 250 microns, from 1 micron to 250 microns, from 10 microns to 250 microns, from 100 microns to 250 microns, from 1 nm to 100 microns, from 10 nm to 100 microns, from 100 nm to 100 microns, from 500 nm to 100 microns, from 1 micron to 100 microns, from 10 microns to 100 microns, from 1 nm to 50 microns, from 10 nm to 100 microns, from 100 nm to 100 microns, from 500 nm to 100 microns, from 1 microns to 100 microns, from 10 microns to 100 microns, from 1 nm to 50 microns, from 10 nm to 50 microns, from 100 nm to 50 microns, from 1 microns to 50 microns, from 10 microns to 50 microns, from 1 nm to 10 microns, from 10 nm to 10 microns, from 100 nm to 10 microns, or from 1 microns to 10 microns.

Following delignification, the graphene may be deposited into at least some of the pores to form graphene-infused wood. The graphene may be deposited in at least 5% of the pores, at least 10% of the pores, at least 15% of the pores, at least 20% of the pores, at least 25% of the pores, at least 30% of the pores, at least 35% of the pores, at least 40% of the pores, at least 45% of the pores, at least 50% of the pores, at least 55% of the pores, at least 60% of the pores, at least 65% of the pores, at least 70% of the pores, at least 80% of the pores, at least 85% of the pores, at least 90% of the pores, or substantially 100% of the pores. The graphene may be deposited in an amount from 1 to 50 g/L of a graphene dispersion.

The graphene-infused wood parts of the space satellite structure may each individually have electrical conductivity of greater than 0 S/m (Siemens per meter), e.g., from 0.1 to 100 S/m, from 1 to 100 S/m, from 10 to 100 S/m, from 25 to 100 S/m, from 50 to 100 S/m, from 75 to 100 S/m, from 0.1 to 75 S/m, from 1 to 75 S/m, from 10 to 75 S/m, from 25 to 75 S/m, from 50 to 75 S/m, from 5 to 100 S/m, from 5 to 75 S/m, from 5 to 50 S/m, from 5 to 25 S/m, from 10 to 100 S/m, from 10 to 75 S/m, from 10 to 50 S/m, or from 10 to 25 S/m.

The graphene-infused wood parts of the space satellite structure may each individually have a density from 0.2 to 0.8 g/cm³, e.g., from 0.2 to 0.6 g/cm³, from 0.2 to 0.5 g/cm³, from 0.3 to 0.8 g/cm³, from 0.3 to 0.6 g/cm³, from 0.3 to 0.5 g/cm³, from 0.4 to 0.8 g/cm³, from 0.4 to 0.6 g/cm³, or from 0.4 to 0.5 g/cm³.

The graphene-infused wood parts of the space satellite structure may each individually have a shielding efficiency of at least 10 dB up to a commercially acceptable value of at least 20, e.g., from 10 to 20 dB, from 12 to 20 dB, or at least 14 dB.

As described herein, the graphene-infused wood material holds many advantages over the state of the art. In addition to the environmental safety advantage explained earlier, wood is a sustainable material sourced from trees. Moreover, the chemical treatment may produce wood with a low density, such as 0.432 g/cm³, which is 84% less dense than aluminum, the main constituent of spacecraft structures. The lower density indicates lower mass and hence reduced mission launch costs. The method of infusion of graphene into delignified wood adds resilience against harsh temperature and radiation conditions of space and it is an easily scalable process for large scale manufacturing.

There are various possible applications of graphene-wood in spacecraft, including structural materials composing the main bus/body of the spacecraft and as components of the electric circuits, such as electromechanical transistors and capacitors. The validity of graphene-wood as a spacecraft material may be demonstrated through a prototype of a CubeSat. CubeSats are modular “stacks” of units of volume, called “U”, that are 10 cm×10 cm×10 cm in volume. CubeSats offer the advantages of a modular design, making them compatible with different launchers, compact sizes and small masses, and commercial off-the-shelf (COTS) components, making them an option for technology demonstration most at a fraction of the cost of conventional spacecraft configurations. The innovative design of the satellite structure described herein is rooted in simplicity, flexibility, and efficiency. Despite its minimalist architecture, it promises robustness and versatility, making it suitable for a wide range of space applications. The design can be used to demonstrate and prove both the design and material innovation.

In conclusion, the space satellite structure design described herein indicates that simplicity can coexist with efficiency. By integrating features that promote case of assembly, flexibility in component placement, and robustness, this design is poised to redefine standards in satellite construction. Whether it's for observational missions, communication, or any other application, the adaptability and strength of this structure make it a top contender in the realm of space engineering.

The present disclosure may be further understood in view of the non-limiting examples included below.

### EXAMPLES

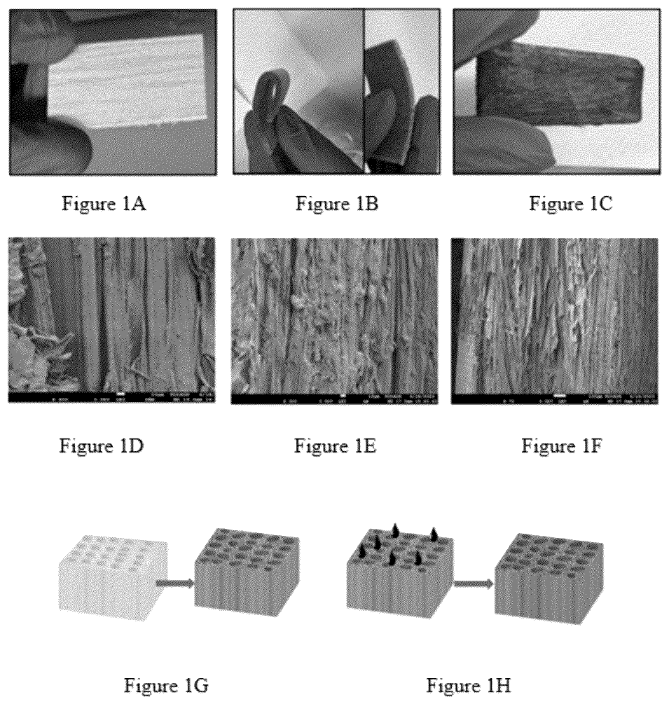

Example 1: Natural wood was provided. An image of the natural wood in shown in FIG. 1A and an SEM (scanning electronic microscopy) image of the natural wood is shown FIG. 1D. Following delignification, an image of the shrunken wood is shown in FIG. 1B with the SEM image shown in FIG. 1E. The shrunken wood was then infused with graphene with the result shown in the image of FIG. 1C and the SEM image of FIG. 1F. The observed scanning electron microscopy (SEM) images in FIGS. 1D-F show the effect of the delignification process on the microstructure of the wood. The process resulted in shrunken wood, which was flexible and moldable, hence any form can be obtained without breaking the wood or affecting its mechanical strength. The dissolving of the lignin matrix made the cell walls more compact and allowed for pores to be introduced into the material, allowing the graphene to be deposited onto the inner surface of cell walls and fibers. A simplified visual of the process is shown in FIG. 1G showing the change from natural wood to delignified wood and in FIG. 1H showing the delignified wood being changed to graphene-infused wood.

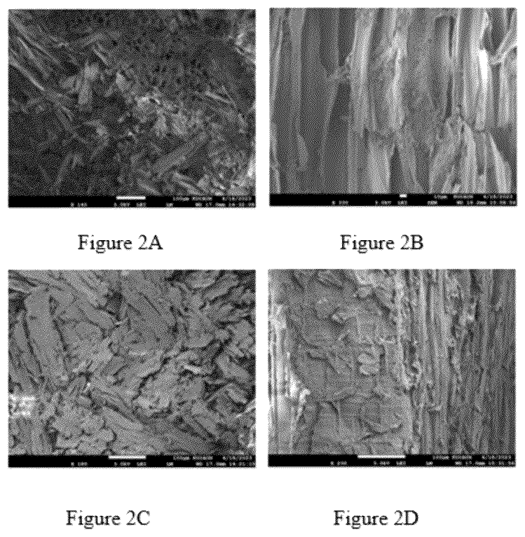

Example 2: Natural wood and the natural wood having been delignified were each infused with 5 g/L of a graphene dispersion. The results are shown in the SEM images in FIGS. 2A-D. FIGS. 2A and 2C shown the natural wood with a graphene dispersion and FIGS. 2B and D show the delignified wood with a graphene dispersion. The natural wood of FIGS. 2A and 2C show a rougher surface where the graphene flakes were separated and deposited perpendicular to the surface. On the other hand, the delignified wood shown in FIGS. 2B and 2B had a smoother surface, allowing the smooth deposition of graphene and hence better coating and enhanced electrical conductivity and electromagnetic interference (EMI) shielding efficiency (SE).

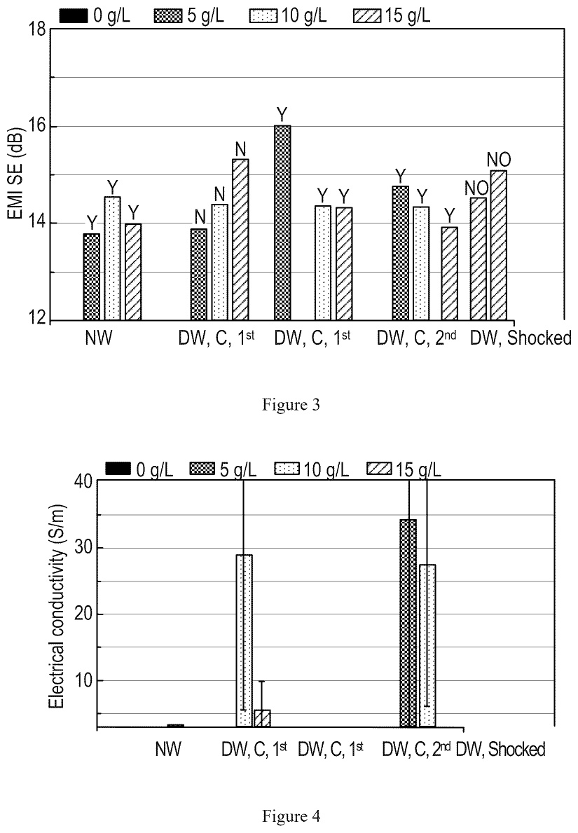

Example 3. Samples of natural wood (NW) and delignified wood (DW) were prepared with varied amounts of graphene infusion. The results are shown in FIG. 3. As shown, EMI SE measurement though the X-band frequency (8.2-12.4 GHZ) was done to confirm the enhanced shielding efficiency of the delignified wood with varied graphene infusion. A value of 16 dB was achieved approaching the requirement for commercial applications (20 dB). Moreover, the electrical conductivity was measured using the Ossila four-point probe system. The samples reached a conductivity of 35 S/m as opposed to the 0 with natural wood as shown in FIG. 4.

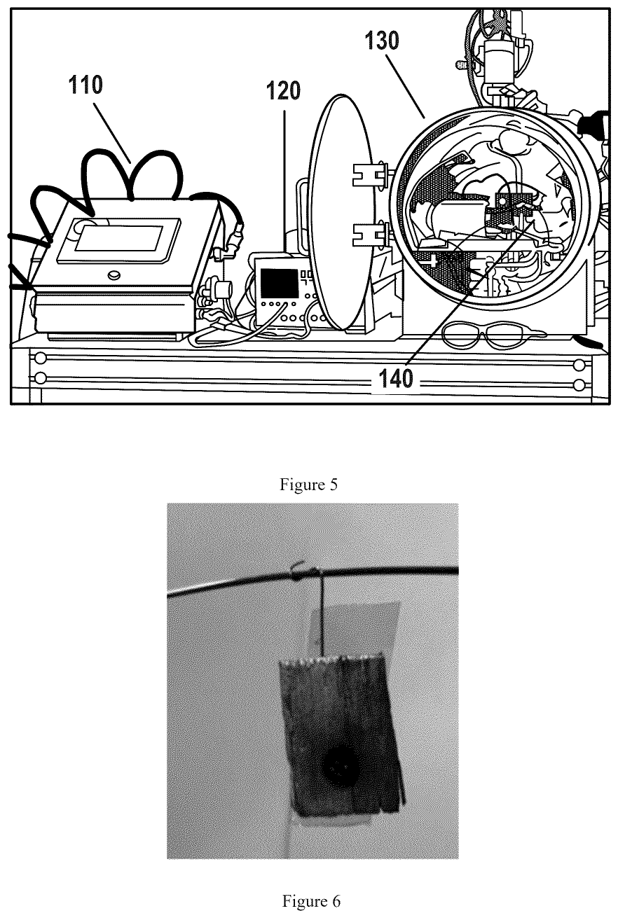

Moreover, to test their performance upon disintegration in vacuum, the samples were placed in a thermal vacuum chamber with the pressure level set to 30 pa. The samples were irradiated with a 4-Watt laser beam for 5 seconds. FIG. 5 shows the set up used for testing. Element 110 is the control; element 120 is the power; element 130 is the thermal surface vacuum chamber; and element 140 is the laser system. FIG. 6 shows the sample upon irradiation. The samples were charcoaled around the ablation spot producing fumes without any detectable spallation particles. It is noteworthy that the samples remained intact when heat-dried in the oven. This indicates the graphene-wood can withstand high temperatures without damage, while also safely disintegrating with the required energy density at the surface.

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

What is claimed is:

1. A space satellite structure comprising:
a bottom base comprising a first graphene-infused wood bracket;
a top base comprising a second graphene-infused wood bracket;
a set of graphene-infused wood ribs coupled to and extending between the bottom base and the top base;
a set of stainless steel threaded bars coupled to and extending between the bottom base and the top base, each stainless steel threaded bar of the set of stainless steel threaded bars being adjacent to a graphene-infused wood rib of the set of graphene-infused wood ribs;
a first set of graphene-infused wood blocks coupled to a bottom side of the bottom base; and
a second set of graphene-infused wood blocks coupled to a top side of the top base.

2. The space satellite structure of claim 1, wherein the first graphene-infused wood bracket comprises from 0.1 to 60% graphene, by weight.

3. The space satellite structure of claim 1, wherein the second graphene-infused wood bracket comprises from 0.1 to 60% graphene, by weight.

4. The space satellite structure of claim 1, wherein at least one of the wood ribs of the set of graphene-infused wood ribs comprises from 0.1 to 60% graphene, by weight.

5. The space satellite structure of claim 1, wherein each of the wood ribs of the set of graphene-infused wood ribs comprises from 0.1 to 60% graphene, by weight.

6. The space satellite structure of claim 1, wherein at least one of the graphene-infused blocks of the first set of graphene-infused blocks comprises from 0.1 to 60% graphene, by weight.

7. The space satellite structure of claim 1, wherein each of the graphene-infused blocks of the first set of graphene-infused blocks comprises from 0.1 to 60% graphene, by weight.

8. The space satellite structure of claim 1, wherein at least one of the graphene-infused blocks of the second set of graphene-infused blocks comprises from 0.1 to 60% graphene, by weight.

9. The space satellite structure of claim 1, wherein each of the graphene-infused blocks of the second set of graphene-infused blocks comprises from 0.1 to 60% graphene, by weight.

10. The space satellite structure of claim 1, further comprising at least one solar panel.

11. The space satellite structure of claim 1, wherein the space satellite structure contains less than 20 individual parts.

12. The space satellite structure of claim 1, wherein the space satellite structure contains less than 10 screws.

13. The space satellite structure of claim 1, wherein at least one side of the space satellite structure is more than 80% open space.

14. A method of forming a graphene-infused wood for the space satellite structure of claim 1, the method comprising:
providing natural wood;
delignifying the natural wood to form a shrunken natural wood comprising pores; and
depositing graphene into the pores to form graphene-infused wood.

15. The method of claim 14, wherein the graphene is deposited on an inner surfaces of cell walls and fibers of the shrunken wood.

16. The method of claim 14, wherein the depositing step comprises depositing from 1 to 50 g/L of a graphene dispersion into the pores of the shrunken natural wood.

17. The method of claim 14, wherein the graphene-infused wood has an electrical conductivity of greater than 0 S/m.

18. The method of claim 14, wherein the graphene-infused wood has an electrical conductivity from 0.1 to 100 S/m.

19. The method of claim 14, wherein the graphene-infused wood has a density from 0.2 to 0.8 g/cm³.

20. The method of claim 14, wherein the graphene-infused wood has a shielding efficiency of at least 10 dB.
